(19) United States
(12) Patent Application Publication
(10) Pub. No.: US 2025/0051586 A1
(43) Pub. Date: Feb. 13, 2025

(54) CLAY CONTAINING PROTECTIVE COATINGS

(71) Applicant: ARMSTRONG WORLD INDUSTRIES, INC., Lancaster, PA (US)

(72) Inventors: John E. HUGHES, Lincoln University, PA (US); Suzanne M. HUNTZINGER, Lancaster, PA (US)

(21) Appl. No.: 18/932,139

(22) Filed: Oct. 30, 2024

Related U.S. Application Data
(63) Continuation of application No. 17/003,055, filed on Aug. 26, 2020.
(60) Provisional application No. 62/891,586, filed on Aug. 26, 2019.

(51) Int. Cl. C09D 5/18; C09D 1/00; C09D 7/20; C09D 7/61; C09D 167/08; E04B 1/94; E04B 9/04; E04C 2/28; E04F 13/08

(52) U.S. Cl. CPC C09D 5/18; C09D 1/00; C09D 7/20; C09D 7/61; C09D 167/08; E04B 1/942; E04B 9/045; E04C 2/28; E04F 13/0866

(57) ABSTRACT

Described herein is a building panel comprising: a substrate; a first coating applied to the substrate, the first coating comprising a flame-retardant composition; a second coating applied to the first coating, the second coating comprising: laponite clay; and a polymeric composition comprising a cured alkyd resin; wherein the building panel comprises an exposed surface formed by the second coating, and wherein the second coating has a solids content of at least 99%.

### CROSS-REFERENCE TO RELATED APPLICATIONS

This application claims the benefit of U.S. patent application Ser. No. U.S. 17/003,055, filed Aug. 26, 2020, which claims the benefit of provisional Patent Application Ser. No. 62/891,586, filed on Aug. 26, 2019, the disclosures of which are incorporated herein by reference.

### BACKGROUND

Building products balance interests with respect to cosmetic value, structural integrity, longevity, and fire safety. Previously, maximizing one or two of the aforementioned interests required sacrificing the remaining interests. For example, improving water-repellency to a surface of a building has offsetting issues with respect to surface toughness against scratch and mar resistance. Thus, there is a need for building panels that can exhibit superior water-repellency while also being capable of having the desired mechanical abrasion characteristics needed by such materials.

### BRIEF SUMMARY

The present invention includes a building panel comprising: a substrate; a first coating applied to the substrate, the first coating comprising a flame-retardant composition; a second coating applied to the first coating, the second coating comprising: laponite clay; and a polymeric composition comprising a cured alkyd resin; wherein the building panel comprises an exposed surface formed by the second coating, and wherein the second coating has a solids content of at least 99%.

Other embodiments of the present invention include a coating composition comprising: a liquid carrier; an alkyd resin; laponite clay; wherein the alkyd resin and the laponite clay are present in a weight ratio of at least 20:1.

Other embodiments of the present invention include a method of forming a coating composition comprising: mixing together an alkyd resin, laponite clay, and liquid carrier to form a blend, wherein the laponite clay is present in an amount ranging from about 0.01 wt. % to about 1.5 wt. % based on the total weight of the blend.

Other embodiments of the present invention include a method of forming a protective coating comprising: a) applying a coating composition to a substrate, the coating composition comprising an alkyd resin, laponite clay, and liquid carrier, wherein the alkyd resin and laponite clay are present in a weight ratio of at least 20:1; b) curing the alkyd resin and drying off the liquid carrier to form the protective coating atop the building panel, the protective coating having a solids content of at least 99 wt. %.

Other embodiments of the present invention include a method of forming a protective coating comprising: a) applying a coating composition to a substrate having a flame-retardant coating applied thereto, wherein the coating composition is applied to the flame-retardant coating atop the substrate, the coating composition comprising an alkyd resin, laponite clay, and liquid carrier; b) curing the alkyd resin and drying off the liquid carrier to form the protective coating atop the substrate, the protective coating having a solids content of at least 99 wt. %.

Other embodiments of the present invention include a building panel comprising: a substrate; a coating applied to the substrate, the coating comprising: laponite clay; and a polymeric composition comprising a cured alkyd resin, the cured alkyd resin and the laponite clay present in a weight ratio of at least 20:1; wherein the building panel comprises an exposed surface formed by the coating, and wherein the second coating has a solids content of at least 99%.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top perspective view of a building panel comprising a coating according to the present invention;

FIG. 2 is a cross-sectional view of the building panel along lines of II-II of FIG. 1;

FIG. 3 is a cross-sectional view of the building panel according to another embodiment of the present invention along lines of II-II of FIG. 1; and

FIG. 4 is a ceiling system comprising a plurality of building panels of FIG. 1.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” less than about 0.1 wt. % based on the total of the referenced value.

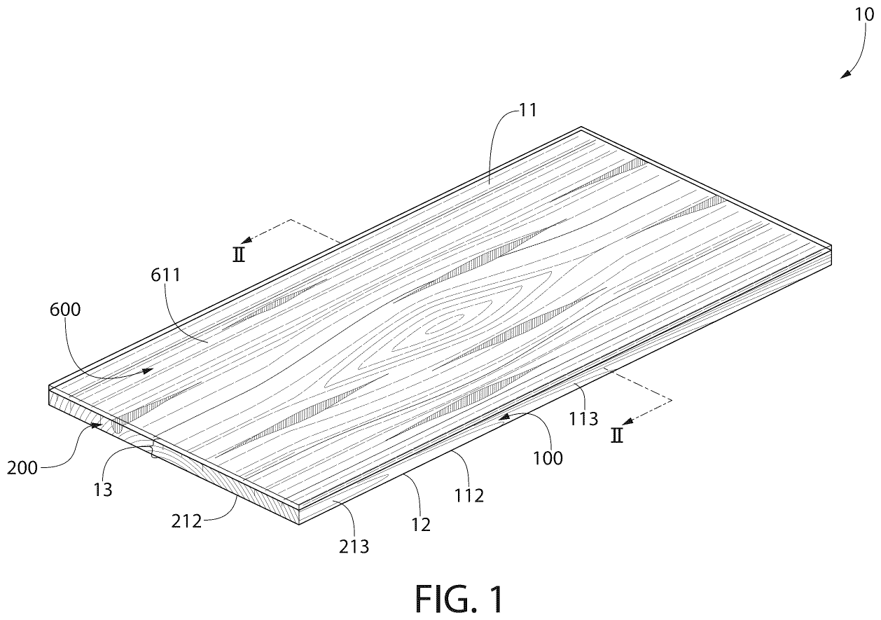

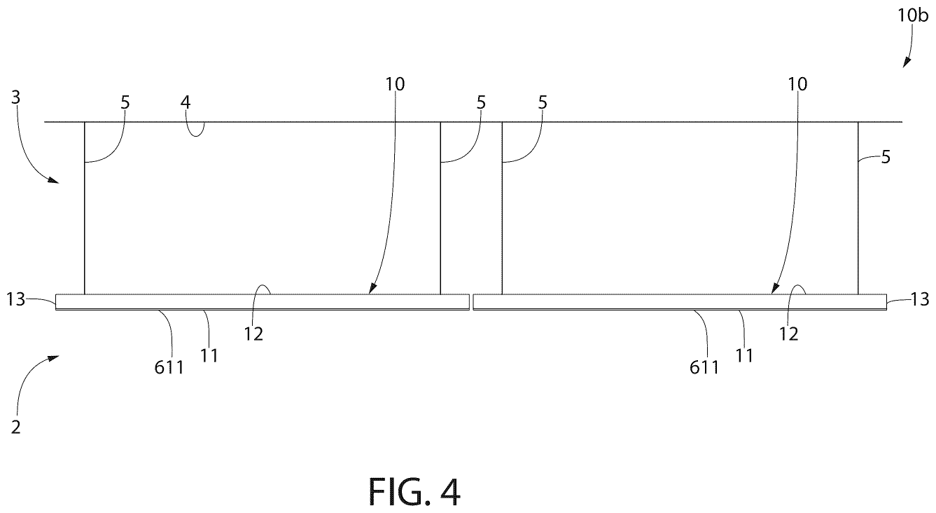

Referring to FIGS. 1 and 4, the present invention includes a ceiling system 1 as well as a building panel 10 that may form part of the ceiling system 1. The building panel 10 of the present invention includes a first major exposed surface 11 opposite a second major exposed surface 12 and an exposed side surface 13 that extends between the first and second major exposed surfaces 11, 12.

The ceiling system I may comprise at least one or more of the building panels 10 installed in an interior space, whereby the interior space comprises a plenum space 3 and an active room environment 2. The plenum space 3 is defined by the space occupied between a structural barrier 4 between floors of a building and the second major exposed surface 12 of the building panel 10. The plenum space 3 provides space for mechanical lines within a building (e.g., HVAC, electrical lines, plumbing, telecommunications, etc.). The active space 2 is defined by the space occupied beneath the first major exposed surface 11 of the building panel 10 for one floor in the building. The active space 2 provides room for the building occupants during normal intended use of the building (e.g., in an office building, the active space would be occupied by offices containing computers, lamps, etc.).

Each of the building panels 10 may be supported in the interior space by one or more supports 5. Each of the building panels 10 are installed such that the first major exposed surface 11 of the building panel 10 faces the active room environment 2 and the second major exposed surface 12 of the building panel 10 faces the plenum space 3. The building panels 10 of the present invention have a superior protective exposed surface as well as superior fire safety performance—particularly when a fire originates in the active room environment 2—without sacrificing the desired aesthetic appearance of the building panel 10, as discussed herein.

Referring to FIG. 1, the building panel 10 may have a panel thickness as measured from the first major exposed surface 11 to the second major exposed surface 12. In a non-limiting embodiment, the panel thickness may range from about 25 mils to about 3,000 mils—including all values and sub-ranges there-between. In some embodiments, the panel thickness may range from about 25 mils to about 600 mils—including all values and sub-ranges there-between. In some embodiments, the panel thickness may range from about 700 mils to about 2,000 mils-including all values and sub-ranges there-between.

The building panel 10 may have a panel length and a panel width. In a non-limiting embodiment, the panel length may range from about 6 inches to about 100 inches—including all values and sub-ranges there-between. In a non-limiting embodiment, the panel width may range from about 2 inches to about 60 inches—including all values and sub-ranges there-between.

The building panel 10 of the present invention comprises a body 100 having a first coating 600 applied thereto. The first coating 600 may be a water-repellent coating. The first coating 600 may be a scratch-resistant coating. The first coating 600 may be both a water-repellent coating and a scratch-resistant coating.

The first coating 600 may comprise an upper surface 611 that is opposite a lower surface 612. The first coating 600 may further comprise a side surface 613 that extends between the upper surface 611 and the lower surface 612.

The side surface 613 of the first coating 600 may form a portion of the exposed side surface 13 of the building panel 10. Stated otherwise, the exposed side surface 13 of the building panel 10 may comprise the side surface 613 of the first coating. The first coating 600 may have a coating thickness “t_{C}” ranging from about 0.5 mils to about 5.0 mils—including all values and sub-ranges there-between-as measured from the upper surface 611 to the lower surface 612 of the first coating 600.

The body 100 may comprise a first major surface 111 opposite a second major surface 112 and a side surface 113 extending there-between. In a non-limiting embodiment, the body 100 may be formed from a cellulosic material (e.g., wood), metal, polymer, and combinations thereof. The body 100 may be formed from a single layer of material (also referred to as an integral structure) or the body 100 may have a laminate structure formed from at least two layers - as described further herein.

Although not pictured, the first coating 600 of the present invention may be applied to a non-woven scrim. Non-limiting examples of non-woven scrim include fiberglass non-woven scrims. The non-woven scrim may form at least one of the first or second major surface 11, 12 of the building panel 10.

The building panel 10 may comprise a decorative pattern that is visible from independently each of the first major exposed surface 11, the second major exposed surface 12, and/or the exposed side surface 13. The decorative pattern may comprise a pattern formed from natural materials, such as cellulosic materials (e.g., wood grain, knots, burl, etc.) or a synthetic material such as a printed ink. In the embodiment exemplified in FIG. 1, the decorative pattern is a wood grain—although the building panel 10 of the present invention is not limited to such decorative pattern as shown in FIG. 1. The decorative pattern of the building panel 10 may be formed a decorative pattern that exists on one of the first major surface 111, the second major surface 112, and/or side surface 113 of the body 100, whereby the body decorative pattern is visible through the first coating 600 applied thereto.

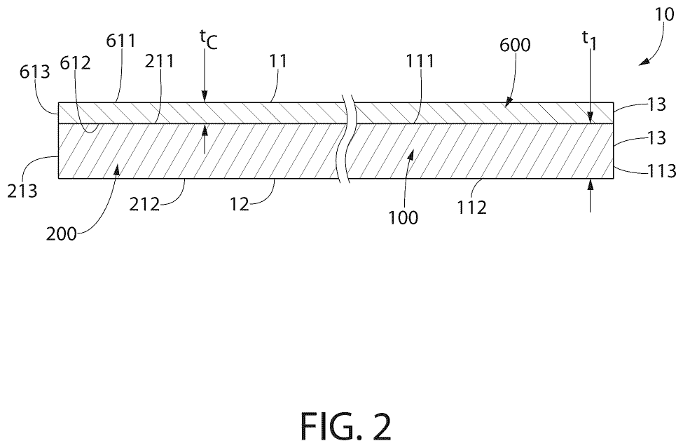

The first coating 600 may be independently applied to each of the first major surface 111, the second major surface 112, and/or the side surface 113 of the body 100. In a preferred embodiment, the first coating 600 is applied to the first major surface 111 of the body 100-as shown in FIG. 2. In such embodiments, the lower surface 612 of the first coating 600 may directly contact the first major surface 111 of the body 100. In such embodiments, the first coating 600 may form at least a portion of the first major exposed surface 11 of the building panel 10. Specifically, the upper surface 611 of the first coating may form at least a portion of the first major exposed surface 11 of the building panel 10. Stated otherwise, the first major exposed surface 11 of the building panel 10 may comprise the first coating 600. Specifically, the first major exposed surface 11 of the building panel 10 may comprise the upper surface 611 of the first coating 600.

The body 100 may be formed from a first substrate layer 200 comprising a first major surface 211 opposite a second major surface 212 and a side surface 213 extending there-between. The first substrate layer 200 may be formed of a cellulosic materials (e.g., wood grain, knots, burl, etc.), a metallic material, or a synthetic material. The first major surface 211 of the first substrate layer 200 may comprise the decorative pattern.

In a non-limiting embodiment, the first substrate layer 200 may have a first thickness t₁ ranging from about 0.25 inches to about 2.0 inches—including all thickness and sub-ranges there-between.

According to this embodiment, the first major surface 211 of the first substrate layer 200 may form the first major surface 111 of the body 100. According to this embodiment, the second major surface 212 of the first substrate layer 200 may form the second major surface 112 of the body 100. Therefore, the first coating 600 may be applied directly to at least one of the first major surface 211 of the first substrate layer 200, the second major surface 212 of the first substrate layer 200, and/or the side surface 213 of the first substrate layer 200.

The first coating 600 may be formed from a first coating composition that comprises a binder and a clay component. The first coating composition may further comprise a coupling agent. The first coating composition may further comprise one or more additives, as discussed further herein.

The first coating 600 of the building panel 10 may be the first coating composition in a dry-state. According to the present invention, the phrase “dry-state” refers to the referenced coating and/or composition being substantially free of a liquid carrier (e.g., liquid water). In the dry-state the referenced coating and/or composition may have less than about 0.1 wt. % of liquid carrier based on the total weight of the referenced coating and/or composition. Therefore, the first coating 600 may be formed by the first coating composition comprising binder, clay component, coupling agent, and one or more additives and having less than about 0.1 wt. % of liquid carrier. In a preferred embodiment, the first coating 600 has a solid's content of about 100 wt. % based on the total weight of the first coating 600.

Conversely, the first coating composition may be applied to either the body 100 in a “wet-state,” which refers to the first coating composition containing various amounts of liquid carrier—as discussed further herein. Therefore, in the wet-state, the first coating composition may comprise binder, clay component, and liquid carrier. In other embodiments, the first coating composition in the wet-state may comprise binder, clay component, coupling agent, and liquid carrier. In other embodiments, the first coating composition in the wet-state may comprise binder, clay component, coupling agent, one or more additives, and liquid carrier.

The liquid carrier may be selected from water, VOC solvent-such as acetone, toluene, methyl acetate—or combinations thereof. In a preferred embodiment, the liquid carrier is water and comprises less than 1.0 wt. % of VOC solvent based on the total weight of the liquid carrier.

In the wet-state, the first coating composition may have a solids content ranging from about 20 wt. % to about 60 wt. %—including all amounts and sub-ranges there-between. In some embodiments, the wet-state, the first coating composition may have a solids content ranging from about 25 wt. % to about 50 wt. %—including all amounts and sub-ranges there- between. In some embodiments, the wet-state, the first coating composition may have a solids content ranging from about 30 wt. % to about 60 wt. %—including all amounts and sub-ranges there-between.

The solid's content is calculated as the fraction of materials present in the coating composition that is not the liquid carrier. Specifically, the solid's content of the coating composition in the wet-state may be calculated as the total amount of the coating composition in the dry-state (i.e., the amount of binder, clay component, coupling agent, and/or additive) and dividing it by the total weight of the coating composition in the wet-state, including liquid carrier. Therefore, the liquid carrier may be present in an amount that is calculated by subtracting the previously mentioned solids content from 100 wt. %—e.g., the liquid carrier may be present in an amount ranging from about 50 wt. % to about 80 wt. %—including all amounts and sub-ranges there-between.

The binder that is present in the first coating 600 may be a polymeric composition. The polymeric composition may be formed by curing an alkyd resin (also referred to as an alkyd emulsion). Non-limiting examples of alkyd emulsion include polyester resins which include residues of polybasic, usually di-basic, acid(s) and polyhydroxy, usually tri-or higher hydroxy alcohols and further including monobasic fatty acid residues. The monobasic residues may be derived (directly or indirectly) from oils (fatty acid triglycerides) and alkyd resins are also referred to as oil modified polyester resins.

The alkyd resins may be cured from residual carboxyl and hydroxyl functionality or by unsaturation (often multiple unsaturation) in the monobasic fatty acid residues. Alkyd resins may include other residues and/or additives to provide specific functionality for the intended end use e.g. sources of additional carboxyl groups may be included to improve water compatibility. One or more catalyst may be blended with an alkyd resin to help accelerate curing.

Alkyd resins may be prepared by reacting a monobasic fatty acid, fatty ester or naturally occurring, partially saponified oil with a glycol or polyol and/or a polycarboxylic acid.

Non-limiting examples of monobasic fatty acid, fatty ester or naturally occurring-partially saponified oil may be prepared by reacting a fatty acid or oil with a polyol. Examples of suitable oils include sunflower oil, canola oil, dehydrated castor oil, coconut oil, corn oil, cottonseed oil, fish oil, linseed oil, oiticica oil, soya oil, and tung oil, animal grease, castor oil, lard, palm kernel oil, peanut oil, perilla oil, safflower, tallow oil, walnut oil. Suitable examples of the fatty acid components of oil or fatty acids by themselves are selected from the following oil derived fatty acids; tallow acid, linoleic acid, linolenic acid, oleic acid, soya acid, myristic acid, linseed acid, crotonic acid, versatic acid, coconut acid, tall oil fatty acid, rosin acid, neodecanoic, neopentanoic, isostearic, 12-hydroxystearic, cottonseed acid with linoleic, linolenic and oleic being more preferred

Non-limiting examples of suitable glycol or polyol include aliphatic, alicyclic, and aryl alkyl glycols. Suitable examples of glycols include: ethylene glycol; propylene glycol; diethylene glycol; triethylene glycol; tetracthylene glycol; pentacthylene glycol; hexacthylene glycol; heptacthylene glycol; octacthylene glycol; nonacthylene glycol; decacthylene glycol; 1,3-propanediol; 2,4-dimethyl-2-ethyl-hexane-1,3-diol; 2,2-dimethyl-1,2-propanediol; 2-ethyl-2-butyl-1,3-propanediol; 2-ethyl-2-isobutyl-1,3-propanediol; 1,3-butanediol; 1,4-butanediol; 1,5-pentanediol; 1,6-hexanediol; 2,2,4-tetramethyl-1,6-hexanediol; thiodiethanol; 1,2-cyclohexanedimethanol; 1,3-cyclohexanedimethanol; 1,4-cyclohexanedimethanol; 2,2,4-trimethyl-1,3-pentanediol; 2,2,4-tetramethyl-1,3-cyclobutanediol; p-xylenediol hydroxypivalyl hydroxypivalate; 1,10-decanediol; hydrogenated bisphenol A; trimethylolpropane; trimethylolethane; pentacrythritol; erythritol; threitol; dipentaerythritol; sorbitol; glycerine; trimellitic anhydride; pyromellitic dianhydride; dimethylolpropicnic acid and the like.

Non-limiting examples of polycarboxylic acid include isophthalic acid, terephthalic acid, phthalic anhydride (acid), adipic acid, tetrachlorophthalic anhydride, dodecanedioic acid, sebacic acid, azelaic acid, 1,4-cyclohexanedicarboxylic acid, 1,3-cyclohexanedicarboxylic acid, maleic anhydride, fumaric acid, succinic anhydride (acid), 2,6-naphthalenedicarboxylic acid, glutaric acid and esters thereof.

The alkyd resin may comprise at least one of chain-stopped oil alkyd emulsion. The chain-stopped oil may be one or more of a short oil, a medium oil, or a long oil. According to the present invention, the term “medium oil” refers to an oil formed from a reactive mixture of fatty acids and hydroxyl-functional compounds, whereby the resin mixture comprises about 40wt. % to about 60 wt. % of the fatty acids. Additionally, the term “long oil” refers to an oil formed from a reactive mixture of fatty acids and hydroxyl-functional compounds, whereby the mixture comprises more than about 60 wt. % of the fatty acids. Additionally, the term “short oil” refers to resin mixture of fatty acids and hydroxyl-functional compounds, whereby the resin mixture comprises less than about 40 wt. % of the fatty acids. The amount of fatty acid in the reaction mixture dictates the chain length of the resulting oil resin-whereby less fatty acid results in a short chain length and more fatty acid results in longer chain length.

Non-limiting examples of medium oil include the reaction product of a polycarboxylic acid and a polyhydric alcohol, in which the acid may be a saturated acid or an alpha, beta unsaturated acid, but preferably those, which are saturated. According to some embodiments, the oils comprising hydroxyl functionality may be further reacted with an isocyanate-functional compound to produce medium oil of polyurethane alkyd emulsion.

The binder may be present in an amount ranging from about 50.0 wt. % to about 90.0 wt. % based on the total weight of the first coating 600—i.e., the first coating composition in the dry-state-including all weight percentages and sub-ranges there-between. In some embodiments, the binder may be present in an amount ranging from about 60.0 wt. % to about 80.0 wt. % based on the total weight of the first coating 600—i.e., the first coating composition in the dry-state—i.e., the first coating 600—including all weight percentages and sub-ranges there-between.

The binder in the first coating 600 is cured alkyd resin. The term “cured” refers to the alkyd resin being further reacted to form additional covalent bonds between the reactive components in the alkyd resin. The term “uncured” refers to the alkyd resin before a curing stage, whereby the resin still comprises functional groups available to participate in the curing reaction.

The coating composition in the wet-state may comprise uncured alkyd resin. The uncured alkyd resin may be present in an amount of about 15.0 wt. % to about 40.0 wt. % based on the total weight of the first coating composition in the wet-state—including all weight percentages and sub-ranges there-between. In some embodiments, the uncured alkyd resin be present in an amount ranging from about 20.0 wt. % to about 35.0 wt. % based on the total weight of the first coating composition in the wet-state—including all weight percentages and sub-ranges there-between.

The first coating 600 may comprise the clay component. The clay component may be a swelling clay. The clay component may be thixotropic. The swelling clay may be laponite.

In an non-limiting embodiment, the clay component may have a particle size that is less than about 60 microns.

The clay component may be present in an amount ranging from about 0.1 wt. % to about 3.0 wt. % based on the total weight of the first coating 600—i.e., the first coating composition in the dry-state-including all weight percentages and sub-ranges there-between. In some embodiments, the clay component may be present in an amount ranging from about 0.1 wt. % to about 1.0 wt. % based on the total weight of the first coating 600—i.e, the first coating composition in the dry-state—including all weight percentages and sub-ranges there-between. The clay component may be present in the coating composition in the wet-state in an amount of about 0.01 wt. % to about 1.5 wt. % based on the total weight of the first coating composition in the wet-state—including all weight percentages and sub-ranges there-between.

The binder and the clay component may be present in a weight ratio of at least 20:1. The weight ratio of the binder and the clay component may range from about 20:1 to about 350:1—including all ratios and sub-ranges there-between. In some embodiments, the weight ratio of the binder and the clay component may be about 105:1. In some embodiments, the weight ratio of the binder and the clay component may be about 348:1.

The first coating composition of the first coating 600 may comprise a coupling agent. The coupling agent may be a silane having generally have the formula (I)

R¹ₙSi(OR²)₄₋ₙ (1)

awherein R¹ represents a lower alkyl group, a phenyl group or a functional group containing at least one of vinyl, acrylic, amino, epoxide, mercapto, or vinyl chloride functional groups; R² is a C1 to C6 alkyl group; and n is a number of 1 to 2.

According to other embodiments, where R¹ is alkyl, preferably, a C₁-C₆alkyl group (the group may be a straight, cyclic, or branched-chain alkyl), such as methyl, ethyl, n-or iso-propyl. n- or iso-butyl, n-pentyl, cyclohexyl. and the like, preferably a C₁-C₄ alkyl group, most preferably a methyl, ethyl, propyl or butyl group), aryl, such as a phenyl, or a functional group or groups, such as vinyl. acrylic, methacrylic, amino, mercapto. or vinyl chloride functional group, e.g., 3,3,3-trifluoropropyl, γ-glycidyloxypropyl, γmethacryloxypropyl, N-(2-aminoethyl)-3-aminopropyl, aminopropyl, and the like; and each R² is, independently, an alkyl group (i.e. a C₁-C₆ straight or branched chain alkyl group, preferably a C₁-C₄ alkyl group, such as a methyl group).

In a non-limiting embodiment, the R¹ may be an epoxide group, whereby the epoxy-functional silane-functional coupling agent may have the formula (II):

glycidoxy(C₁-C₃-alkyl)(tri-C₁-C₃-alkoxy)silane (II)

In some embodiments, the compound of formula (II) may include compounds such as, 3-glycidoxypropyltrimethoxysilane, 3-glycidoxypropyldiisopropylethoxysilane, (3-glycidoxypropyl methyldiethoxysilane, 3-glycidoxypropyltriethoxysilane, and epoxy-functional silane compounds represented by the formula (IV))

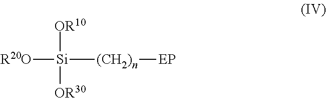

wherein R¹⁰, R²⁰ and R³⁰, independently, represent aliphatic or aromatic groups, especially, lower alkyl of from 1 to 6 carbon atoms, preferably C₁-C₃ alkyl, and ‘EP’ represents glycidyl (e.g., glycidyloxy), cyclohexane oxide (epoxycyclohexyl) or cyclopentane-oxide (epoxycyclopentyl); and n is a number of from I to 4, preferably 1. 2 or 3.

As examples of the epoxy functional compounds represented by formula (IV), mention may be made of, for example, gamma-glycidyloxymethyltrimethoxysilane, gamma-glycidyloxymethyltriethoxysilane, gamma-glycidoxymethyl-tripropoxysilane, gamma-glycidoxymethyl-tributoxysilane, beta-glycidoxyethyltrimethoxysilane, beta-glycidox yethyltriethoxysilane, beta-glycidoxyethyl-tripropoxysilane, beta-glycidoxyethyl-tributoxysilane, beta-glycidoxyethyltrimethoxysilane, alpha-glycidoxyethyl-tricthoxysilane, alpha-glycidoxyethyl-tripropoxysilane, alpha-glycidoxyethyltributoxysilane, gamma-glycidoxypropyl-trimethoxysilane, gamma-glycidoxypropyl-triethoxysilane, gamma-glycidoxypropyl-tripropoxysilane, gamma- glycidoxypropyltributoxysilane, beta-glycidoxypropyl-trimethoxysilane, beta-glycidoxypropyl-tricthoxysilane, beta-glycidoxypropyl-tripropoxysilane, beta-glycidoxypropyl-tributoxysilane, alpha-glycidoxypropyl-trimethoxysilane, alpha-glycidoxypropyl-triethoxysilane, alpha-glycidoxypropyl-tripropoxysilane, alpha-glycidoxypropyl-tributoxysilane, gamma-glycidoxybutyl-trimethoxysilane, delta-glycidoxybutyl-triethoxysilane, delta-glycidoxybutyl-tripropoxysilane, delta-glycidoxybutyl-tributoxysilane, delta-glycidoxybutyl-trimethoxysilane, gamma-glycidoxybutyl-triethoxysilane, gamma-glycidoxybutyl-tripropoxysilane, gamma-alpropoxybutyl-tributoxysilane, delta-glycidoxybutyl-trimethoxysilane, delta-glycidoxybutyl-triethoxysilane, delta-glycidoxybutyl-tripropoxysilane, alpha-glycidoxybutyl-trimethoxysilane, alpha-glycidoxybutyl-triethoxysilane, alpha-glycidoxybutyl-tripropoxysilane, alpha-glycidoxybutyl-tributoxysilane, (3,4-epoxycyclohexyl)-methyl-trimethoxysilane, (3,4-epoxycyclohexyl)methyl-trietboxysilane, (3,4-epoxycyclohexyl)methyl-tripropoxysilane, (3,4-epoxycyclohexyl)-methyl-tributoxysilane. (3,4-epoxycyclohexylethyl-trimethoxysilane, (3.4-epoxycyclohexyl)ethyl-triethoxysilane, (3,4-epoxycyclohexyl)ethyl-tripropoxysilane, (3,4-epoxycyclohexyl)-ethyl-tributoxysilane, (3,4-epoxycyclohexyl)propyl-trimethoxysilane. (3,4-epoxycyclohexyl)propyl-triethoxysilane, (3,4-epoxycyclohexyl)propyl-tripropoxysilane, (3,4-epoxycyclohexyl)propyl-tributoxysilane, (3,4-epoxycyclohexyl)butyl-trimethoxysilane. (3.4-epoxycyclohexyl)butyl-triethoxysilane, (3,4-epoxycyclohexyl)butyl-tripropoxysilane, (3,4-epoxycyclohexyl)butyl-tributoxysilane.

As examples of silanes of formula (I), wherein R′ is an alkyl group or aryl group, and n is 1, mention may be made of, for example, methyltrimethoxysilane, etbyltrimethoxysilane, ethyltricthoxysilane. n-propyltrimethoxysilane. n-propyltriethoxysilane, isopropyltrimethoxysilane, n-butyltrimethoxysilane. isobutyltrimethoxysilane, phenyltrimethoxysilane, preferably Methyltrimethoxysilane, phenyltrimethoxysilane, and mixtures thereof.

In a non-limiting embodiment, the R¹ may be an amino group, whereby the amine-functional silane-functional coupling agent may be selected from one or more of aminoethyl-triethoxysilane, beta-amino-ethyltrimethoxysilane, beta-aminoethyl-triethoxysilane, beta-amino-ethyl-tributoxysilane. beta-aminoethyltripropoxysilane. alpha-aminoethyl-trimethoxysilane, alpha-aminoethyl-triethoxysilane, gamma-aminopropyltrimethoxysilanc, gamma-aminopropyl-triethoxysilane, gamma-aminopropyl-tributoxysilane, gamma-amino-propyltripropoxysilane, beta-aminopropyl-trimethoxysilane. beta-aminopropyl-triethoxysilane, beta-amino-propyltripropoxysilane, beta-aminopropyl-tributoxysilane, alpha-aminopropyl-trimethoxysilane, alpha-aminopropyltriethoxysilane, alpha-aminopropyl-tributoxysilane, alpha-aminopropyl-tripropoxysilane, N-aminomethylaminoethyl-trimethoxysilane, N-aminomethylaminomethyl-tripropoxysilane, N-aminomethyl-beta-aminoethyl-trimethoxysilane, N-aminomethyl-beta-aminoethyl-triethoxysilane, N-aminomethyl-beta-aminoethyl-tripropoxysilane, N-aminomethyl-gamma-aminopropyl-trimethoxysilane, N-aminomethyl-gamma-aminopropyl- triethoxysilane, N-aminomethyl-gamma-aminopropyl-tripropoxysilane. N-aminomethyl-beta-aminopropyl-trimethoxysilane, N-aminomethyl-beta-aminopropyl-triethoxysilane, N-aminomethyl-beta-aminopropyl-tripropoxysilane. N-aminopropyltripropoxysilane. N-aminopropyl-trimethoxysilane. N-(beta-aminoethyl)-beta-aminoethyl-trimethoxysilane, N-(beta-aminoethyl)-beta-aminoethyl-triethoxysilane, N-(beta-aminoetbyl)-beta-aminoethyl-tripropoxysilane, N-(beta-aminoethyl)-beta-aminocthyl-trimethoxysilane. N-(beta- aminoethyl)-alpha-aminoethyl-triethoxysilane, N-(beta-aminoethyl)-alpha-aminoethyl-tripropoxysilane, N-(beta-aminocthyl)-beta-aminopropyl-trimethoxysilane, N-(beta-aminoethyl)-gamma-aminopropyl-triethoxysilane, N-(beta-aminoethyl)-gamma-aminopropyl-tripropoxysilane. N-(beta-aminocthyl)-gamma-aminopropyl-trimethoxysilane, N-(beta-aminoethyl)-beta-aminopropyl-triethoxysilane, N-(beta-aminoethyl)-beta-aminopropyl-tripropoxysilane, N- (gamma-aminopropyl)-beta-aminoethyl-trimethoxysilane, N-(gamma-aminopropyl)-beta-aminoetbyl-triethoxysilane, N-(gamma-aminopropyl)-beta-aminoethyl-tripropoxysilane, N-methyl aminopropyl trimethoxysilane, beta-aminopropyl methyl diethoxysilane, gamma-diethylene triaminepropyltriethoxysilane, and the like.

The coupling agent may be present in an amount ranging from about 1.0 wt. % to about 3.0 wt. % based on the total weight of the first coating 600—i.e., the first coating composition in the dry-state-including all weight percentages and sub-ranges there-between. In some embodiments, the coupling agent may be present in an amount ranging from about 1.5 wt. % to about 2.5 wt. % based on the total weight of the first coating 600—i.e, the first coating composition in the dry-state-including all weight percentages and sub-ranges there-between.

The coupling agent may be present in the coating composition in the wet-state in an amount of about 0.1 wt. % to about 1.5 wt. % based on the total weight of the first coating composition in the wet-state-including all weight percentages and sub-ranges there-between.

The coupling agent may react with one or more components of the first coating composition—such as the alkyd resin—as well as a portion of the an underlying surface that the first coating composition is applied to. Therefore, in the first coating 600, the original monomeric coupling agent may be modified as a covalent bond is formed with other components of the alkyd resin and/or underlying surface the first coating composition is applied to.

The first coating 600 may further comprise one or more additives. In a non-limiting example, the additives may include one or more of catalyst, defoamer, anti-microbial agents, surfactants, wetting agents, rheology modifiers, emulsifiers, and fire retardants.

Non-limiting examples of catalyst include metal-including catalyst. The catalyst may be selected to facilitate the curing reason of the alkyd resin. The catalyst may be present in an amount ranging from about 0.5 wt. % to about 2.0 wt. % based on the weight of the first coating 600.

Non-limiting examples of defoamers include polyether polysiloxane compounds. The defoamer may be present in an amount ranging from about 0.1 wt. % to about 0.5 wt. % based on the weight of the first coating 600.

Non-limiting examples of anti-microbial agents include anti-bacterial compounds, anti-fungal compounds, and blends thereof. The anti-microbial agent may be present in an amount ranging from about 5.0 wt. % to about 10.0 wt. % based on the weight of the first coating 600.

Non-limiting examples of surfactants include ionic surfactants, non-ionic surfactants, and blends thereof. Ionic surfactants may include anionic surfactant. Non-ionic surfactants may comprise ethoxylated compounds. Surfactants may be present in an amount ranging from about 0.01 wt. % to about 0.2 wt. % based on the weight of the first coating 600.

Non-limiting examples of rheology modifiers include alkali swellable compounds. The rheology modifiers may be present in an amount ranging from about 0.1 wt. % to about 1.0 wt. % based on the weight of the first coating 600.

The first coating 600 may be formed by applying the first coating composition in the wet-state to at least one of the first major surface 111, the second major surface 112, and/or a side surface 113 of the body 100. The first coating composition may be applied in the wet-state in an amount ranging from about 3.0 g/ft² to about 15.0 g/ft²—including all amounts and sub-ranges there-between. In a preferred embodiment, the first coating composition may be applied in the wet-state in an amount ranging from about 7.0 g/ft to about 11.0 g/ft²—including all amounts and sub-ranges there-between.

Once applied, the first coating composition may dry such that the liquid carrier is driven off. Additionally, the alkyd resin cures to form the polymeric composition. After drying, all liquid carrier is driven off thereby leaving the first coating 600—i.e., the coating composition in the dry-state. The first coating 600 may be present in an amount ranging from about 1.5 g/ft² to about 8.0 g/ft²—including all amounts and sub-ranges there-between. In a preferred embodiment, the first coating 600 may be present in an amount ranging from about 3.0 g/ft² to about 8.0 g/ft²—including all amounts and sub-ranges there-between.

The first coating composition may be dried and cured at a temperature ranging from about room temperature to about 121° C.—including all thicknesses and sub-ranges there-between. According to the present invention, room temperature is the temperature measured under atmospheric pressure (1 atm) and ranges from about 68° F. to about 74° F. (about 20° C. to about 23° C.)

The first coating 600 of the present invention provides a clear (or substantially clear) protective coating on the building panel 10. Specifically, the first coating 600 provides a clear, water-resistant protective coating to the underlying body 100. For the purposes of this application, the phrases “substantially clear” or “substantially transparent” refers to materials that have the property of transmitting light in such a way that a normal, human eye (i.e., one belonging to a person with so-called “20/20” vision) or a suitable viewing device can see through the material distinctly. The level of transparency should generally be one which permits a normal, human eye to distinguish objects having length and width on the order of at least 0.5 inches and should not significantly distort the perceived color of the original object. The coating 600 is substantially clear (or substantially transparent) such that the underlying body decorative feature can be visible from the upper major surface 11 of the building panel 10 as the decorative pattern 30 on the overall building panel 10, as discussed further herein. The term “substantially clear” or “substantially transparent” may also refer to the coating having at least 70% optical clarity, whereby 100% optical clarity refers to an underlying surface being completely unhindered visually by the first coating 600.

Furthermore, it has been surprisingly discovered that the additional of the clay component to the first coating composition provides an unexpected improvement to both the water repellency of the resulting first coating 600 as well as the hardness and crosshatch adhesion strength of the first coating 600. Additionally, the unexpected the improvement in water repellency, hardness, and crosshatch strength did not diminish the desired optical properties of the first coating 600.

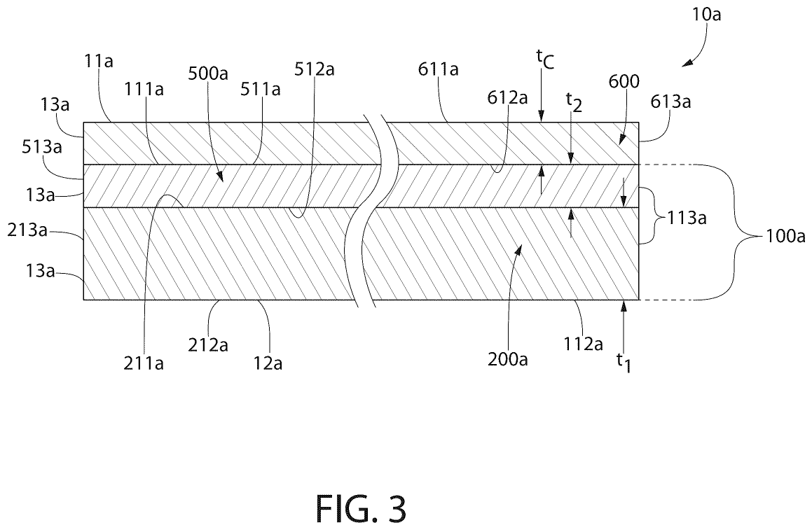

Referring now to FIG. 3, a building panel 10a is illustrated in accordance with another embodiment of the present invention. The building panel 10a is similar to the building panel 10 except as described herein below. The description of the building panel 10 above generally applies to the building panel 10a described below except with regard to the differences specifically noted below. A similar numbering scheme will be used for the building panel 10a as with the building panel 10 except that an “a” suffix will be used.

The building panel 10a of this embodiment comprises a body 100a that includes at least two layers. The first layer may be the first substrate layer 200a comprising a first major surface 21 la opposite a second major surface 212a and a side surface 213a extending there-between. The body 100a may further comprise a second coating 500a.

The second coating 500a may comprise a upper surface 511a opposite a lower surface 512a and a side surface 513a extending there-between. The second coating 500a may be applied directly to the first substrate layer 100a. Specifically, the second coating 500a may be applied directly to at least one of the first major surface 211a of the first substrate layer 200a, the second major surface 212a of the first substrate layer 200a, and/or the side surface 213a of the first substrate layer 200a. In a preferred embodiment, the second coating 500a is applied to the first major surface 211a of the first substrate layer 200a.

According to this embodiment, at least one of the first major surface 111a of the body 100a, the second major surface 112a of the body 100a, and/or the side surface 113a of the body 100a is formed by the second coating 500a.

Specifically, the first major surface 111a of the body 100a may be formed by the upper surface 511a of the second coating 500a, whereby the second major surface 512a of the second coating 500a faces the first major surface 211a of the first substrate layer 200a. In some embodiments, the second major surface 112a of the body 100a may be formed by the first major surface 511a of the second coating 500a, whereby the lower surface 512a of the second coating 500a faces the second major surface 211a of the first substrate layer 200a. In some embodiments, the side surface 113a of the body 100a may be formed by the upper surface 511aof the second coating 500a, whereby the lower surface 512a of the second coating 500a faces the side surface 213a of the first substrate layer 200a.

The second coating 500a may have a second thickness t₂ as measured between the upper surface 511a and the lower surface 512a of the second coating 500a. In a non-limiting embodiment, the second thickness t₂ may range from about 0.5 to about 6.0—including all thicknesses and sub-ranges there-between.

The second coating 500a may be a flame retardant coating. The flame-retardant coating may comprise a silicate compound. Non-limiting examples of the silicate compound may include potassium silicate, tetraethyl orthosilicate, and combinations thereof.

The silicate compound may be present in an amount ranging from about 50 wt. % to about 98 wt. %—including all wt. % and sub-ranges there-between-based on the total weight of the second coating 500a in the dry-state. The second coating 500a may further comprise alumina trihydrate. The alumina trihydrate may be present in an amount ranging from about 0.5 wt. % to about 12.5 wt. %-including all wt. % and sub-ranges there-between-based on the total weight of the second coating 500a in the dry-state.

The first coating 600a may be independently applied to each of the first major surface 111a, the second major surface 112a, and/or the side surface 113a of the body 100a-whereby at least one of the first major surface 111a, the second major surface 112a, and/or the side surface 113a of the body 100a is formed by the second coating 500a.

As demonstrated by FIG. 3, the first coating 600a may be applied to the first major surface 111a of the body 100a-as shown in FIG. 2. In such embodiments, the second coating 500a may be applied to the upper major surface 211a of the first substrate layer 200a. In such embodiments, the first major exposed surface 11a of the building panel 10a may be formed by the first coating 600a-specifically, the upper surface 611a of the first coating 600a may form the first major exposed surface 11a of the building panel 10a. The lower surface 612a of the first coating 600a may directly contact the upper surface 511a of the second coating 500, and the lower surface 512a of the second coating may directly contact the first major surface 211a of the first substrate layer 200a.

According to this embodiment, the first major surface 211 of the first substrate layer 200 may form the first major surface 111 of the body 100. According to this embodiment, the second major surface 212 of the first substrate layer 200 may form the second major surface 112 of the body 100. Therefore, the first coating 600 may be applied directly to at least one of the first major surface 211 of the first substrate layer 200, the second major surface 212 of the first substrate layer 200, and/or the side surface 213 of the first substrate layer 200.

### EXAMPLES

A set of experiments were prepared to test the surprising improvement in hardness, crosshatch adhesion, and water repellency due to the addition of laponite clay with the alkyd resin based coatings.

A number of coating formulations using swellable clay were prepared. Comparative Examples 1-3 use a swellable clay that is hectorite clay. Examples 1 and 2, which are representative of the present invention, use a swellable clay that is laponite clay.

TABLE 1

| | Comp. | Comp. | Comp. | | |
|---|---|---|---|---|---|
| | Ex. 1 | Ex. 2 | Ex. 3 | Ex. 1 | Ex. 2 |
| Liquid Carrier | 74.8 | 74.8 | 73.8 | 70.0 | 55.2 |
| Binder | 23.6 | 23.6 | 23.6 | 21.0 | 34.8 |
| Hectorite Clay | 0.4 | 0.4 | 0.4 | — | — |
| Laponite Clay | — | — | — | 0.2 | 0.1 |
| Coupling Agent | 0.5 | 0.5 | 0.5 | 0.4 | 1.0 |
| Aluminum Hydroxide | — | — | — | 3.0 | 3.5 |
| Catalyst | 0.4 | 0.4 | 0.4 | 0.4 | 0.4 |
| Defoamer | 0.1 | 0.1 | 0.1 | 0.1 | 0.1 |
| Anti-Fungal Agent | — | — | — | 3.0 | 3.5 |
| Surfactant// | 0.2 | 0.2 | 1.2 | 1.9 | 1.4 |
| Wetting Agent// | | | | | |
| Rheology Modifier/ | | | | | |
| emulsifier | | | | | |
| Total | 100.0 | 100.0 | 100.0 | 100.0 | 100.0 |
| Pencil Hardness | H | H | H | 4H | 4H |
| Crosshatch Adhesion | 3B-4B | 3B-4B | 3B-4B | 4B | 5B |
| Water Repellency | 90 min | 180 min | 165 min | 240 min | 240 min |

As demonstrated by Table 1, the addition of the laponite clay provides an improvement in pencil hardness, crosshatch adhesion, and water repellency. Of importance, the improvement in pencil hardness, crosshatch adhesion, and water repellency was unexpected as coatings containing other, non-laponite, swellable clays did not perform nearly as well as the laponite clay-based coatings. Furthermore, the laponite clay-based coatings performed exceedingly well in amounts that were even smaller than the non-laponite clay based coatings.

What is claimed is:

1. A building panel comprising:
a substrate;
a first coating applied to the substrate, the first coating comprising a flame-retardant composition;
a second coating applied to the first coating, the second coating comprising:
laponite clay; and
a polymeric composition comprising a cured alkyd resin;
wherein the building panel comprises an exposed surface formed by the second coating, and wherein the second coating has a solids content of at least 99%.

2. The building panel according to claim 1, wherein the flame-retardant composition comprises a silicate.

3. The building panel according to claim 1, wherein the laponite clay is present in an amount ranging from about 0.1 wt. % to about 3 wt. % based on the total weight of the second coating.

4. The building panel according to claim 1, wherein the polymeric composition is present in an amount ranging from about 50 wt. % to about 90 wt. % based on the total weight of the second coating.

5. The building panel according to claim 1, wherein the polymeric composition and laponite clay are present in a weight ratio of at least 20:1.

6. The building panel according to claim 1, wherein the second coating further comprises a coupling agent.

7. The building panel according to claim 6, wherein the coupling agent is a silane-functional.

8. The building panel according to claim 1, wherein the cured alkyd resin is formed from an alkyd resin comprising short oil chain-stopped alkyd emulsion.

9. The building panel according to claim 1, wherein the second coating is present in an amount ranging from about 1.5 g/ft² to about 8.0 g/ft².

10. The building panel according to claim 1, wherein the substrate comprises a cellulosic material.

11. A building panel comprising:
a substrate;
a coating applied to the substrate, the coating comprising:
laponite clay; and
a polymeric composition comprising a cured alkyd resin, the cured alkyd resin and the laponite clay present in a weight ratio of at least 20:1;
wherein the building panel comprises an exposed surface formed by the coating, and wherein the second coating has a solids content of at least 99%.

12. The building panel according to claim 11, wherein the laponite clay is present in an amount ranging from about 0.1 wt. % to about 3 wt. % based on the total weight of the coating.

13. The building panel according to claim 11, wherein the polymeric composition is present in an amount ranging from about 50 wt. % to about 90 wt. % based on the total weight of the coating.

14. The building panel according to claim 11, wherein the second coating further comprises a coupling agent.

15. The building panel according to claim 14, wherein the coupling agent is a silane-functional.

16. The building panel according to claim 11, wherein the cured alkyd resin is formed from an alkyd resin comprising at least one of a short-oil chain stopped alkyd emulsion and a medium-oil chain stopped alkyd emulsion.

17. The building panel according to claim 11, wherein the coating is present in an amount ranging from about 1.5 g/ft² to about 8.0 g/ft².

18. The building panel according to claim 11, wherein the substrate comprises a cellulosic material.

19. A method of forming a protective coating comprising:
a) applying a coating composition to a substrate, the coating composition comprising an alkyd resin, laponite clay, and liquid carrier, wherein the alkyd resin and laponite clay are present in a weight ratio of at least 20:1;
b) curing the alkyd resin and drying off the liquid carrier to form the protective coating atop the building panel, the protective coating having a solids content of at least 99 wt. %.

20. The method according to claim 19, wherein the coating composition is applied to the building panel in step a) in an amount ranging from about 3.0 g/ft² to about 15.0 g/ft².
